(19) United States
(12) Patent Application Publication
(10) Pub. No.: US 2012/0224955 A1
(43) Pub. Date: Sep. 6, 2012

(54) DIFFUSER

(76) Inventor: Andrew Vine, London (GB)

(21) Appl. No.: 13/395,289

(22) PCT Filed: Sep. 24, 2010
(86) PCT No.: PCT/GB10/01801

§ 371 Date: May 22, 2012

(30) Foreign Application Priority Data
Sep. 25, 2009 (GB) 0916901.2

(51) Int. Cl. F03B 11/02

(52) U.S. Cl. 415/208.1

(57) ABSTRACT

A diffuser having a flow path including generally annular regions arranged to direct a flow of fluid with both tangential and axial velocity components.

The present invention relates to a diffuser. For example, it relates to a diffuser having an annular flow area increasing in the axial direction and a passageway having tangential and axial directional components and defined by a flow guiding member.

A conventional radial (or centrifugal) compressor (or pump) has a rotor, typically driven by a turbine or an electric motor, with a plurality of generally radial blades which divert axially-flowing inlet fluid such as air to provide a pressure rise. Often, a diffuser in the form of passageways between radial-tangential vanes on the inner surface of an enclosing wall is provided to slow down the fluid flow and convert the kinetic energy of the fluid flow to a pressure rise. In such known devices, the fluid leaving the rotor has a substantial tangential velocity component and a radial velocity component of a value typically between one half to one quarter of the tangential velocity component.

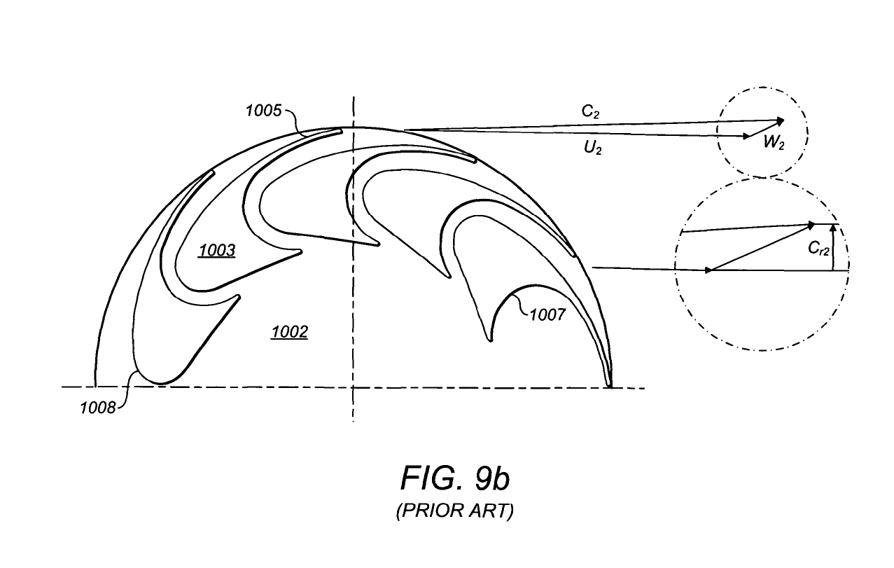

FIGS. 9a and 9b show a known radial (or centrifugal) compressor having an axial diffuser (not illustrated), a radial diffuser 1000 including a plurality of radial-tangential vanes 1001, and a rotor 1002 including a plurality of rotor blades 1003. To reduce shock losses and excessive circumferential variation in static pressure, there exists a distinct radially-extending gap, or “vaneless space” 1004, between the tips 1005 of the rotor blades 1003 and the leading edges of the radial-tangential vanes 1001. This vaneless space 1004 allows the uneven air flow leaving the rotor blades 1003 time to settle and even out its velocity before entering the passageways 1006 between the radial-tangential diffuser vanes 1001 and subsequently moving to the axial diffuser. This type of design is used to make the compressor more compact, but it is only possible to turn the flow into the axial direction after it has been decelerated within the vaneless space 1004 and the radial-tangential vanes 1001 of the radial diffuser 1000.

WO 2005/024242, which is incorporated herein by reference, describes a rotor for use with the type of radial-tangential diffuser vanes identified above. The rotor may be used in a low specific speed compressor such that the rotor blades produce a rotor exit flow having a high ratio of tangential-to-radial velocity, typically an order of magnitude more than in the conventional machines described above. However, the known radial-tangential diffusers of conventional machines do not exploit effectively the comparatively low radial flow component produced by such rotors.

It is an object of the present invention to alleviate the problems of the prior art at least to some extent.

The invention is set out in the claims.

According to a first aspect of the invention, the axially extending and substantially uninterrupted inlet region of increasing cross-sectional area and the substantially uninterrupted passageway of the flow guide region advantageously provide for a fluid flow having a relatively low radial velocity component and a relatively high tangential velocity component to decrease in absolute velocity and increase in pressure in the axial downstream direction. This provides for a reduction in the diameter and length of the diffuser.

The passageway having tangential and directional components advantageously provides for a fluid flow having a relatively low radial velocity component and a relatively high tangential velocity component to decrease in absolute velocity and increase in pressure in the axial downstream direction. This provides for a reduction in the diameter and length of the diffuser.

According to a second aspect of the invention, the inlet region being provided radially adjacent the rotor periphery and increasing in cross-sectional area in the downstream direction and the flow guide region including a substantially uninterrupted passageway having tangential and axial directional components and defined by a flow guiding member advantageously provide for a reduction in the radial velocity component, and an increase in the axial velocity component, of a fluid flow. This provides for a reduction in the diameter and length of the diffuser and for constant flow conditions around the annular flow area, thereby reducing noise and vibration and improving flow stability.

According to a third aspect of the invention, the diffuser stages stacked to form a conical profile advantageously provide for a reduction in the diameter and length of a diffuser assembly.

Preferred embodiments of the present invention will now be more particularly described, by way of example, with reference to the accompanying drawings in which:

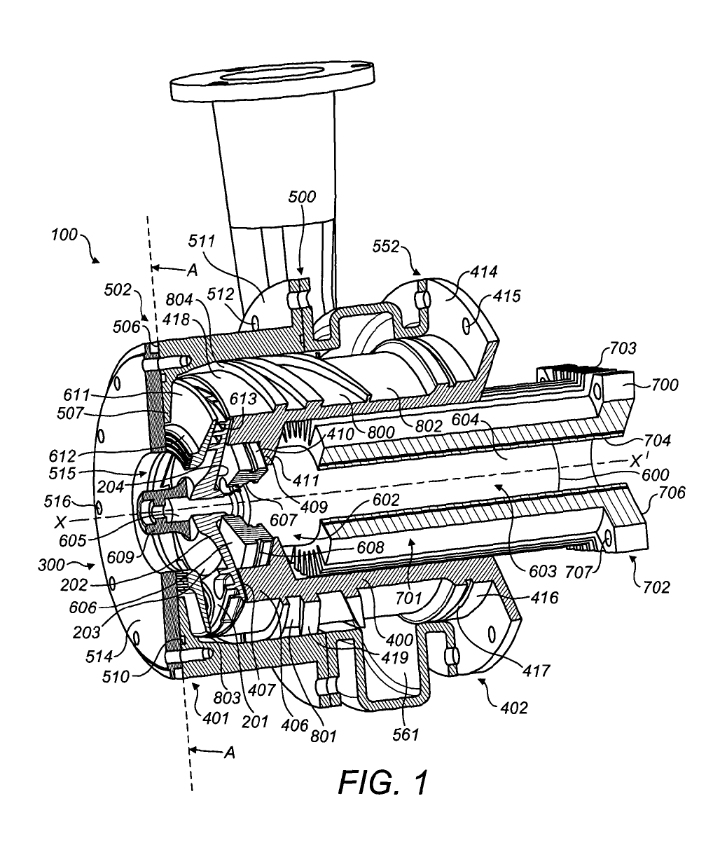

FIG. 1 shows a cutaway, perspective view of a radial (centrifugal) compressor assembly including a diffuser having an inner tube and an outer casing;

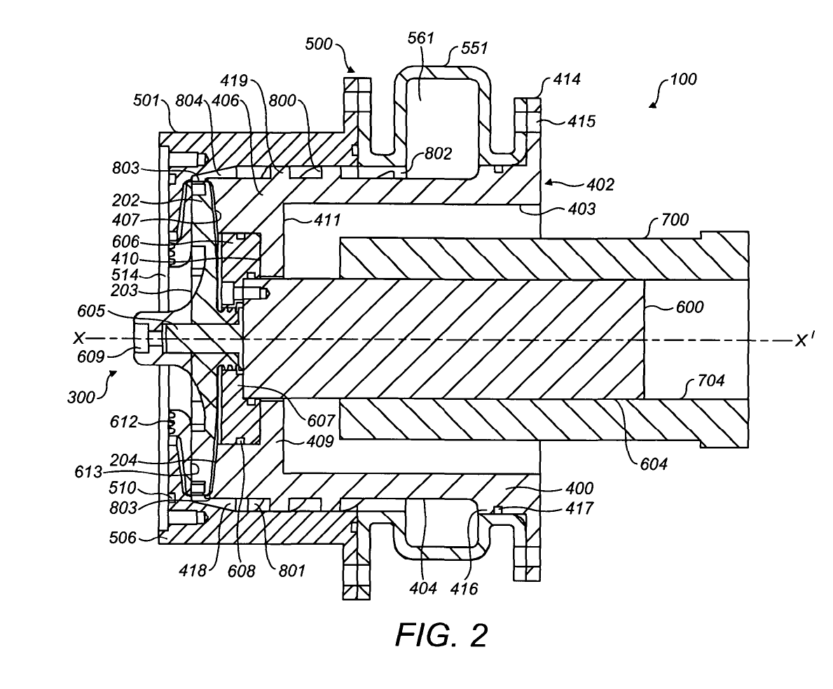

FIG. 2 shows a section of the radial (centrifugal) compressor assembly of FIG. 1;

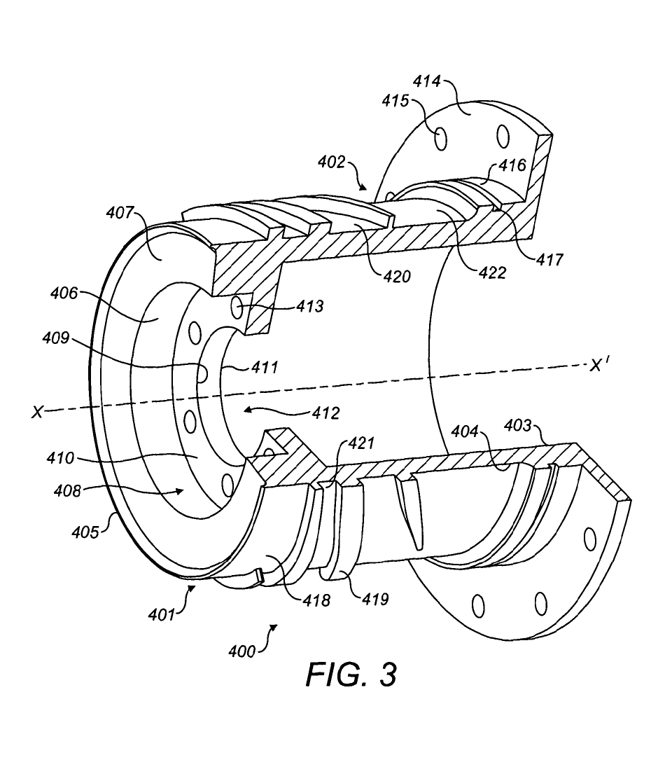

FIG. 3 shows a cutaway, perspective view of the inner tube of the diffuser of FIGS. 1 and 2;

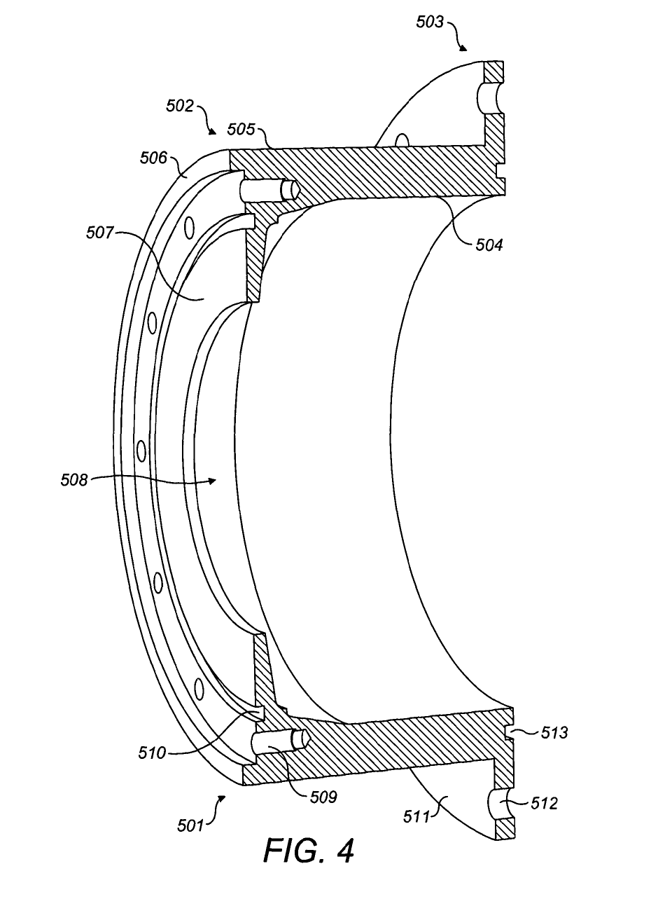

FIG. 4 shows a cutaway, perspective view of a generally cylindrical flow guiding portion of the outer casing of the diffuser of FIGS. 1 and 2;

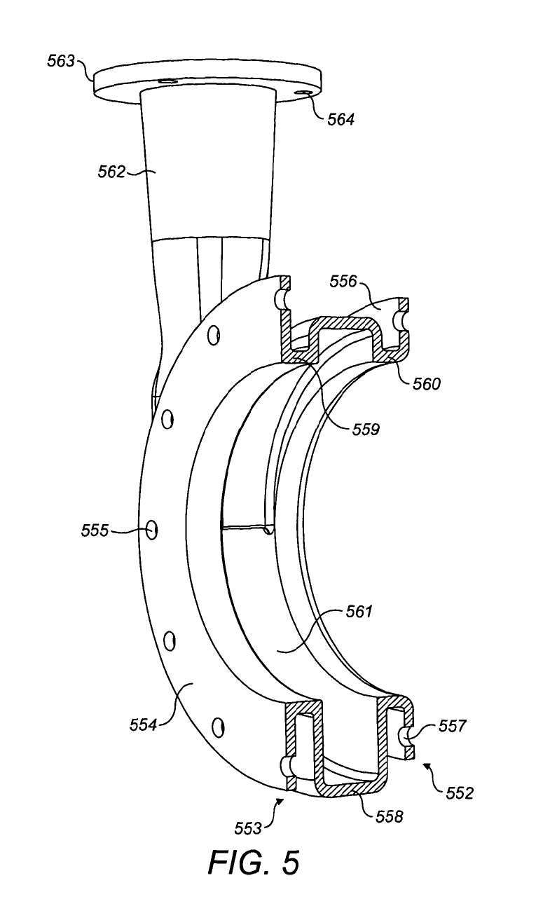

FIG. 5 shows a cutaway, perspective view of a chamber portion of the outer casing of the diffuser of FIGS. 1 and 2;

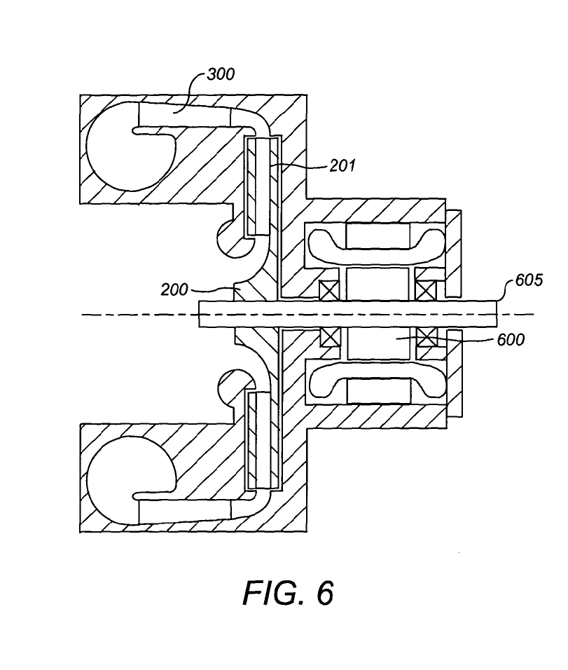

FIG. 6 shows a sectional view of a diffuser and motor each oppositely oriented with respect to a rotor;

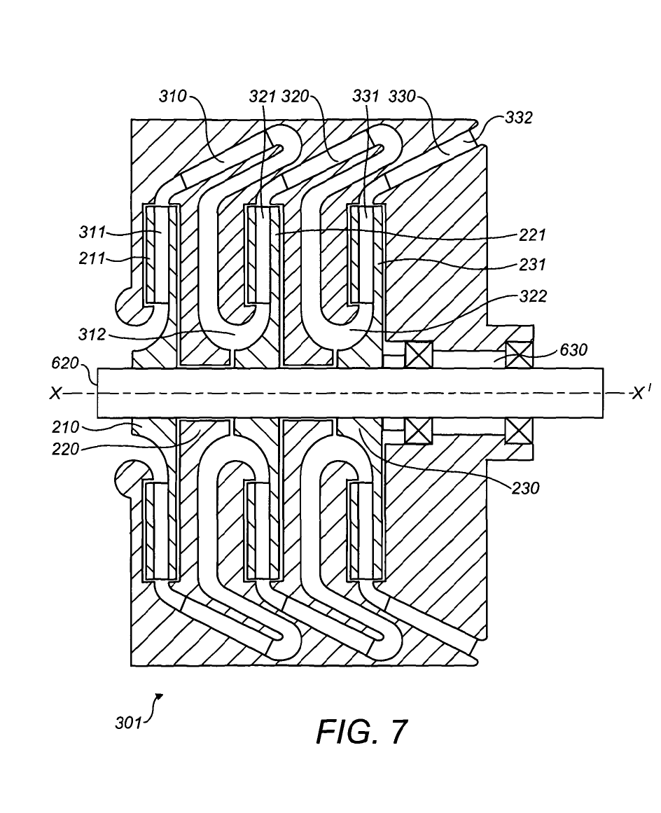

FIG. 7 shows as sectional view of a plurality of staged diffusers and a motor;

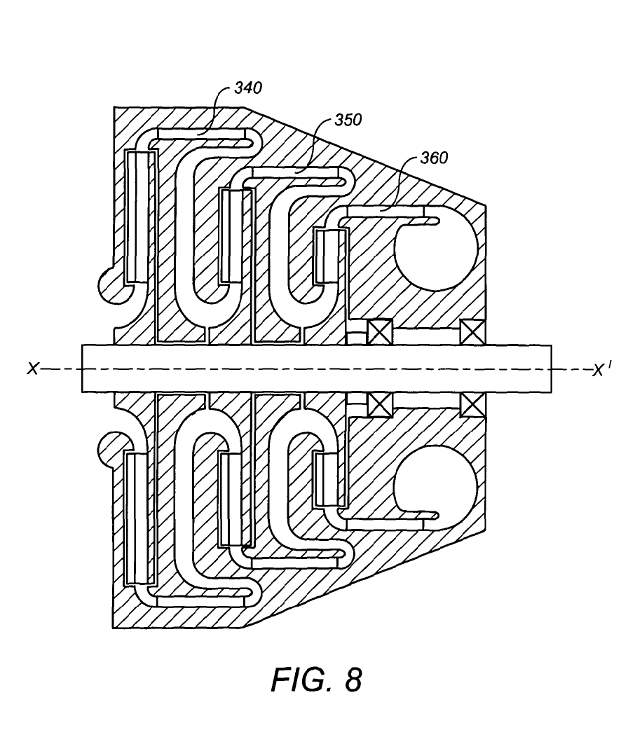

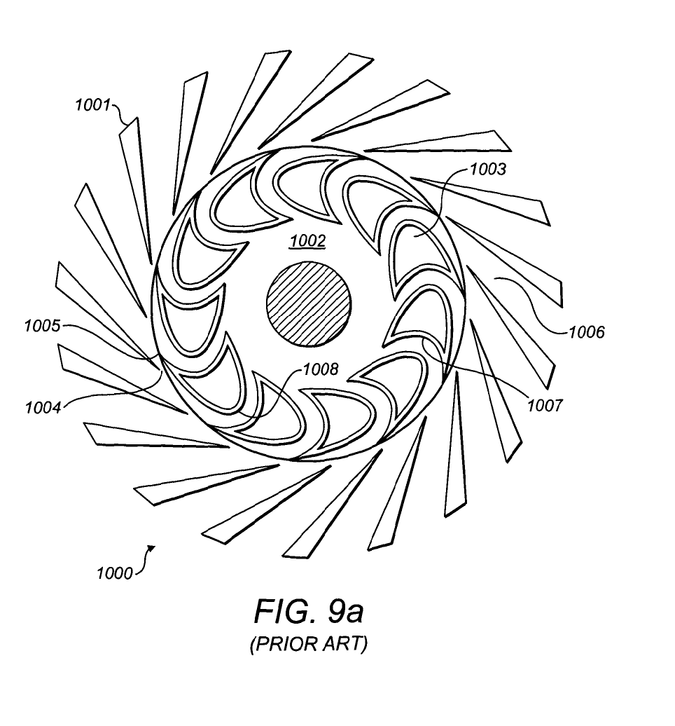

FIG. 8 shows a sectional view of a plurality of staged diffusers of different sizes and a motor; and

FIG. 9a shows a sectional view of a prior art radial (or centrifugal) compressor having a rotor; and FIG. 9b shows the rotor of FIG. 9a in more detail.

In overview, in an embodiment the diffuser is suitable for use with a compressor (or other device) having a rotor, such as, but not limited to, the rotor of FIGS. 9a and 9b described above, which delivers a flow having a relatively low radial velocity component and a relatively high tangential velocity component.

The diffuser has a flow path extending between its inlet and outlet ends. The flow path includes an axially extending substantially uninterrupted flow-smoothing region upstream of one or more passageways, for example in the form of an axially-extending spiral or helix, for example defined by an uninterrupted or substantially uninterrupted spiral or helical flow guiding member, arranged to direct the flow with both tangential or circumferential and axial velocity components, thereby reducing the absolute velocity of the flow and producing an increase in static pressure. When the flow leaves the rotor it has a relatively very high tangential component and a relatively low radial component. Hence when the flow goes around what appears in radial cross-section to be a sharp radial-axial bend, the radius of curvature of the gas flow path is actually quite large, for example because it is shifting relatively unconstrained from a primarily tangential direction to an axial-tangential direction, so this is possible without high pressure losses. In this way the diffuser 300 exploits effectively the comparatively low radial flow velocity component produced by the rotor. Because the diffuser 300 achieves this by directing the flow with an axial and tangential velocity component, the diffuser 300 has no need for the radial-tangential diffuser vanes of the prior art, thereby reducing the diameter of the rotodynamic machine in which the compressor is installed. Further, the inlet end axially provides an expanding area which provides for effective diffusion of flow.

Referring to FIG. 1, a radial (centrifugal) compressor assembly 100 has a rotor 200 including a plurality of forward-swept rotor blades 201, a diffuser 300 comprising an inner tube 400 and an outer casing 500, a motor 600, and a heat-sink 700 used where additional motor cooling is required.

The inner tube 400 and the outer casing 500 of the diffuser 300 are machined from steel and have respective first ends 401, 502 and second ends 402, 552. The outer casing 500, inner tube 400, heat-sink 700, motor 600, and rotor 200 are arranged concentrically about a common longitudinal axis X-X′. The motor 600 is accommodated by the heat-sink 700, the heat-sink 700 is accommodated by the inner tube 400, and the inner tube 400 is accommodated by the outer casing 500.

Referring also to FIGS. 2 and 3, the cylindrical wall of the inner tube 400 has an inner curved surface 403 and an outer curved surface 404, and varies in thickness in the axial direction between the first and second ends 401, 402.

The first end 401 is tapered and terminates at a lip 405 defined by a recessed, inwardly-depending ring 406 having a generally concave face 407. The ring 406 includes a central hole 408 and extends axially toward the second end 402 of the inner tube 400.

Adjacent the ring 406 is an inwardly-depending mounting flange 409 having first and second faces 410, 411. The mounting flange 409 includes a central hole 412 and extends axially from the ring 406 toward the second end 401 of the inner tube 400. The mounting flange 409 further includes a plurality of holes 413 for receiving securing bolts (not shown).

The second end 402 of the inner tube 400 terminates in a radially-projecting attachment flange 414 having a plurality of holes 415 for receiving securing bolts (not shown).

Adjacent the attachment flange 414, a radially-projecting portion 416 of the cylindrical wall of the inner tube 400 extends outwardly from the outer curved surface 404 and extends axially toward the first end 401. The radially-projecting portion 416 includes a circumferential groove 417 for receiving an ‘O’ ring seal (not shown)

Turning to aspects related to operation of the inventive features, a generally plain and smooth portion 418 of the outer curved surface 404 extends from the lip 405 to approximately one sixth of the way to the second end 402. Six, evenly-spaced and radially-projecting flow guide members 419 extend outwardly from the outer curved surface 404. Each flow guide member 419 further extends partially around the circumference of the outer curved surface 404 to form a spiral or helix extending in a direction having tangential and axial components, from the generally plain and smooth or substantially uninterrupted portion 418 toward the second end 402. In the embodiment shown the flow guide members 419 thus define between them six spiral flow passageways 800 each having an inlet 801 and an outlet 802. The flow guide members 419 are tapered outwardly in the downstream axial direction and spaced apart from one another such that each spiral flow passageway 800 widens between its inlet 801 and its outlet 802, thereby causing the cross-sectional area of each flow passageway 800 to increase in the downstream axial direction. As will be apparent, any number of flow guide members 419 and spiral flow passageways 800 can be provided as appropriate.

In the embodiment shown the passageways 800 have an inlet angle of between about 70 and 80 degrees with respect to the longitudinal axis X-X′. The guide members 419 and hence the passageways 800 are substantially uninterrupted, that is to say they are continuous over an arc angle (i.e. the angle which the uninterrupted portions extend around the circumference or longitudinal axis X-X′) of, for example, 60 degrees or more. Thus the passageways 800 provide for effective diffusion of flow.

The generally cylindrical and elongate motor 600 has a housing 601 including respective first and second ends 602, 603 and an outer curved surface 604. The diameter of the housing 601 is approximately equal to the diameter of the hole 412 of the mounting flange 409 of the inner tube 400. The motor 600 further includes a driveshaft 605 extending from the first end 602.

The generally cylindrical and elongate heat-sink 700 is for cooling the motor and has respective first and second ends 701, 702 and a plurality of radially-disposed cooling fins 703 defining an inner curved surface 704 configured to match the outer curved surface 604 of the motor housing 601. At the second end 702 the fins 703 extend further radially to define a generally square mounting flange 706 having a hole 707 at each of its four corners for receiving a securing bolt (not shown).

The heat-sink 700 is arranged concentrically in the inner tube 400 about the common X-X′ axis such that there exists an axial gap between the first end 701 of the heat-sink 700 and the second face 411 of the mounting flange 409. Because the outer diameter of the radially-disposed fins 703 of the heat-sink 700 is smaller than the inner diameter of the inner tube 400, there also exists a radial gap between the extremities of the fins 703 and the inner curved surface 403 of the inner tube 400.

A portion of the outer curved surface 604 of the motor housing 601 is received by, and is in contact with, the inner curved surface 704 of the heat-sink 700, such that the second end 603 of the motor housing 601 is contained by the heat-sink 700 and the first end 602 of the motor housing 601 projects beyond the first end 701 of the heat-sink 700 through the hole 412 of the mounting flange 409.

The recessed ring 406 contains a motor flange disc 606 adjacent to and in abutment with the ring 406 and the first face 410 of the mounting flange 409. The motor flange disc 606 has a stepped portion 607 in abutment with the first end 602 of the motor housing 601, thereby restraining axial movement of the motor 600. The motor flange disc 606 further includes a circumferential groove 608 for receiving an ‘O’ ring seal (not shown) for providing a gas-tight seal between the motor flange disc 606 and the ring 406.

The motor driveshaft 605 extends through the motor flange disc 606 and the hole 408 of the ring 406 and terminates in the region of the first end 502 of the outer casing 500. A rotor clamp 609 having an efficient aerodynamic shape is removably attached to the terminus of the motor driveshaft 605 and extends axially beyond the first end 502 of the outer casing 500.

The rotor 200 includes a rotor disc 202 having a first face 203 including a plurality of forward-swept rotor blades 201, and a generally convex second or rear face 204. The rotor disc 202 further includes a central hole 205 for receiving the motor driveshaft 605. The rotor disc 202 is removably attached to the motor driveshaft 605 by a screw fitting. The rotor disc 202 is axially restrained by both the rotor clamp 609, which is in abutment with a central portion of the first face 203, and the motor flange disc 606, which is in abutment with a central portion of the second face 204. The generally convex second face 204 is configured to match the generally concave face 407 of the ring 406, and there exists a small clearance gap between the faces 204, 407.

In one embodiment, the rotor 1002 is as shown in FIG. 9b and has very thick blades 1003 which reduce the flow such that the radial velocity can be extremely low relative to the tangential velocity without causing instability problems. The ratio of tangential to radial velocity C_{θ2} to Cₘ₂ can be up to 25:1 which is an order of magnitude above the limits for conventional designs. When the flow leaves the rotor 1002 it is essentially tangential and not radial so when the flow goes around what appears in radial cross-section to be a sharp radial-axial bend, the radius of curvature of the gas is actually quite large so this is possible without high losses. Such a rotor 1002 has swept forward partial entry blades 1003, that is, the blades 1003 are curved forwardly in the direction of rotation. In particular the forward sweep is turned extensively towards the tangential direction in the direction of rotor 1002 rotation such that the resultant exit flow from the exaggerated forward swept flow passage has a tangential velocity greater than the velocity of the compressor blade 1003 tips. The rotor blade 1003 can be solid or hollow and includes a concave forward face 1007 in the direction of flow and an increased curvature concave rear face 1008 forming generally a “D” shape profile pointing away from the direction of flow. The blade 1003 occupies a significant proportion of the volume of the rotor space as a result, a “dead space” being defined between the front and rear faces 1007, 1008. The forward face 1007 is angled generally tangentially and in the direction of flow at the radially innermost inlet region and curves through approximately 180 degrees to extend generally tangentially once again at the radially outer most exit region. The opposing rear face 1008 of an adjacent blade 1003 is profiled to provide a curved flow passage therebetween which exits generally tangentially and is of generally constant width. The specific profile of the blades/volumes of the blades 1003 depends on the gas being compressed and the rotor speed and can be optimised for each case. The exit blade angle is preferably between 20 degrees and 90 degrees (tangential) to a radius of the rotor 1002, as long as sufficient forward speed is provided to allow the flows in the passages of the compressor to re-converge, minimising the pulsation effect.

A rotor sealing ring 610 has a first face 611 including a plurality of circular concentric ribs 612 projecting perpendicularly to the first face 611, and a generally flat second face 613. The rotor sealing ring 610 depends inwardly from the lip 405 such that the second face 613 is adjacent the rotor blades 201 with a small axial gap therebetween, and the concentric ribs 612 project axially to the first end 502 of the outer casing 500.

Referring now also to FIGS. 4 and 5, the outer casing 500 has a generally cylindrical flow guiding portion referred to hereinafter as an axial flow guide 501, and a chamber portion downstream thereof referred to hereinafter as a volute 551.

The axial flow guide 501 is arranged concentrically around a portion of the inner tube 400 about the common X-X′ axis. The axial flow guide 501 has respective first or upstream and second or downstream ends 502, 503, and a cylindrical wall having respective inner and outer curved surfaces 504, 505. A plurality of holes 509 extend axially into the cylindrical wall for receiving securing bolts (not shown). The inner curved surface 504 is in abutment with the flow guide members 419, thereby closing and fully defining the flow passageways 800 as annular passageways.

The first end 502 is tapered and terminates at a lip 506 defined by a recessed, inwardly-depending and tapered closure flange 507. The closure flange 506 includes a central hole 508 and extends axially toward the second end 552 of the outer casing 500. The closure flange 506 further includes a circumferential groove 510 for receiving an ‘O’ ring seal (not shown).

The inwardly-depending and tapered closure flange 507 is located adjacent the lip 405 to define an opening, referred to hereinafter as a flow inlet duct 803. The tapered first end 502 defines an annular channel, referred to hereinafter as an annular flow inlet 804, which is bounded by the inner curved surface 504 and the generally plain and smooth portion 418, and which is axisymmetric and divergent in the axial direction towards the second end 503.

The second end 503 of the axial flow guide 501 terminates in a radially-projecting mating flange 511 extending outwardly and including a plurality of holes 512 for receiving securing bolts (not shown). The mating flange 511 further includes a circumferential groove 513 for receiving an ‘O’ ring seal (not shown).

The volute 551 is arranged concentrically around a portion of the inner tube 400 about the common X-X′ axis. The volute 551 has respective first and second ends 553, 552. The first end 553 terminates in a radially-projecting mating flange 554 extending outwardly to a diameter equal to the diameter of the mating flange 511 of the second end 503 of the axial flow guide 501. The mating flange 554 includes a plurality of holes 555 for receiving securing bolts (not shown) and is removably attached to the mating flange 511 of the second end 503 of the axial flow guide 501 by the bolts which pass through the respective holes 555, 512. An ‘O’ ring seal (not shown) in the circumferential groove 513 provides a gas-tight seal between the mating flanges 554, 511.

The second end 552 of the volute 551 terminates in a radially-projecting attachment flange 556 extending outwardly to a diameter equal to the diameter of the attachment flange 414 of the inner tube 400. The attachment flange 556 includes a plurality of holes 557 for receiving securing bolts (not shown) and is removably attached to the attachment flange 414 of the inner tube 400 by the bolts which pass through the respective holes 557, 415.

A generally U-shaped (in cross-section), radially-projecting channel portion 558 defines the volute wall and has respective first and second flange portions 559, 560 which extend to the mating flange 554 and the attachment flange 556 of the volute 551, thereby defining a channel 561 between the mating flange 554 and the attachment flange 556. The channel portion 558 extends outwardly to a radius which exceeds the radius at the lip 506 and which varies around the circumference of the volute 551. Thus, the cross-section of the channel 561 is varied around the circumference of the volute 551.

The second flange portion 560 of the channel portion 558 is in abutment with the radially-projecting portion 416 of the cylindrical wall of the inner tube 400. An ‘O’ ring seal (not shown) in the circumferential groove 417 provides a gas-tight seal between the second flange portion 560 and the radially-projecting portion 416.

The volute 551 further includes a flow tube 562 for fluid outlet extending generally tangentially from the channel 561 and projecting outwardly beyond the lip 506. The flow tube 562 has a generally rectangular cross-section which transitions to a generally divergent, conical cross-section. The flow tube 562 terminates at an attachment flange 563 having a plurality of holes 564 for receiving securing bolts (not shown).

A closure plate 514 (see FIG. 1) includes a central hole 515 and a plurality of holes 516 for receiving securing bolts (not shown). The closure plate 514 is removably attached to the closure flange 507 of the outer casing 500 by the bolts passing through the holes 516 of the closure plate 514 and into the holes 509 of the cylindrical wall of the axial flow guide 501. An ‘O’ ring seal (not shown) in the circumferential groove 510 provides a gas-tight seal between the closure plate 514 and the closure flange 507. In addition, the closure plate 514 is in abutment with the concentric ribs 612 of the first face 611 of the rotor sealing ring 610, thereby providing a sealed flow path to the central portion of the rotor disc 202.

Thus, there is defined a flow path extending between the respective upstream or inlet first ends 401, 502 and downstream or outlet second ends 402, 552 of the inner tube 400 and the outer casing 500. From the foregoing it is apparent that the flow path includes four distinct flow regions. The first flow region is at the flow inlet duct 803 extending generally radially adjacent the rotor blades 201 (or 1003, FIGS. 9a, 9b). This region is associated with a relatively large tangential velocity component and small radial velocity component of air leaving the rotor blades 201 (or 1003, FIGS. 9a, 9b). Because of the radial adjacency, without requiring, for example, a radially-extending flow passage but merely providing, for example, operational clearance for the rotor tips, the inner curved surface 403 (or wall) of the inner tube 400 advantageously provides for a reduction in the radial velocity component, and an increase in the axial velocity component, of a fluid flow. This provides for a reduction in the diameter and length of the diffuser. Additionally it will be seen that the area of the first flow region increases radially in the axial downstream direction providing an expanding area. Further, or alternatively, the wall 403 slopes radially outwardly. Further, or alternatively, the axial exit area is smaller, preferably significantly smaller, than the cylindrical area of the rotor exit. This is consistent with a compressor rotor of a type which delivers low radial and axial velocity such that the flow can be turned into the axial direction into a passage of relatively low radial height without incurring high pressure losses since the resulting axial velocity will still be low.

The second flow region extends generally axially and is at the annular flow inlet 804 extending divergently along the generally plain and smooth portion 418 of the flow path from the flow inlet duct 803 to the inlets 801 or entry/upstream ends of the plurality of spiral flow passageways 800. This region is associated with predominant tangential and axial velocity components.

The third flow region is at the annulus having the plurality of spiral or helical passageways 800, extending generally axially and tangentially/circumferentially, which increase in cross-sectional area in the axial direction toward the second end 402 of the inner tube 400 and terminate at the plurality of outlets 802. This region is associated with predominant tangential and axial velocity components.

The fourth flow region is at the circumferential channel 561 of the volute 551 which varies in cross-section, and the generally divergent, tangential outlet flow tube 562. This region is associated with predominant tangential and radial velocity components.

In use, the driveshaft 605 of the motor 600 rotates to turn the rotor disc 202 which takes in air at its centre and delivers it to the rotor blades 201. The rotor blades 201 accelerate the air and deliver it to the inlet duct 803 with a relatively low radial velocity component and a substantial tangential velocity component.

The radial velocity component of the flow is reduced to a small fraction of its original value (or to zero) by the inner curved surface 504, which partly defines the annular flow inlet 804 and is in close proximity to the tips of the rotor blades 201. The flow is guided in the axial direction by the annular flow inlet 804 such that it follows a generally circumferential path with a small axial flow component. Thus the flow passes along and through the divergent annular flow inlet 804 and is generally decelerated as it does so. Because the annular flow inlet 804 is axisymmetric, the flow therein experiences constant conditions regardless of the angular position of the rotor 200.

With its absolute velocity having been reduced and significantly evened out around the circumference of the generally plain and smooth annular flow inlet 804, the flow subsequently enters the inlets 801 of the spiral flow passages 800 in a direction substantially parallel to the flow guide members 419. Since the cross-sectional area of the spiral flow passageways 800 increases in the axial direction, the absolute velocity of the flow is further reduced as the flow passes through and along the passageways 800.

The decelerated flow then leaves the outlets 802 of the spiral flow passageways 800 and enters the channel 561 having undergone a substantial increase in static pressure. The absolute velocity of the flow is further reduced as it passes through the increasing cross-section of the channel 561 and exits the diffuser through the generally divergent flow tube 562.

Thus, the diffuser 300 exploits effectively the comparatively low radial flow component produced by the rotors by providing a large radius of curvature for gas flow through the annular flow area along the diffuser to produce a reduction in flow velocity and an increase in static pressure without high pressure losses. This advantageously provides for constant and stable flow conditions along the diffuser, thereby reducing noise and vibration. Moreover, because the diffuser 300 achieves this by directing the flow with a significant axial velocity component, the diffuser 300 has no need for the radial-tangential diffuser vanes of the prior art. Hence, the diameter of the rotodynamic machine may be reduced, thereby offering the possibility for a more compact machine.

In an embodiment of the invention, the diffuser is not arranged around the motor. Referring to FIG. 6, a rotor, for example of the type described above, is mounted on a driveshaft 605 of a motor 600. The diffuser 300 is located adjacent but axially-spaced relative to the motor 600 such that the direction of air flow is generally away from the motor 600.

In other embodiments of the invention, the plain and smooth portion 418 of the outer curved surface 404 extends from the lip 405 to a distance other than approximately one sixth of the way to the second end 402.

In an embodiment of the invention, at least a portion of one or both of the inner tube 400 and outer casing 500 is generally conical such that the cross-sectional area of the flowpath increases in the axial direction.

In embodiments of the invention, a plurality of diffusers are connected together to form a series of diffuser stages. Referring to FIG. 7, a diffuser assembly 301 has three stages of similar, generally conical diffusers 310, 320, 330, having respective inlets 311, 321, 331 and respective outlets 312, 322, 332, connected in series. Each diffuser 310, 320, 330 is associated with a respective rotor 210, 220, 230 having respective rotor blades 211, 221, 231. The rotors 210, 220, 230 are mounted on a common driveshaft 620 attached to a motor 630.

In use, the flow passes from the first rotor blade 211 (or 1003, FIGS. 9a, 9b) to the inlet 311 of the first diffuser 310 and leaves the outlet 312 of the first diffuser 310 having experienced a reduction in absolute velocity and an increase in static pressure as described above. The flow then passes to and from the second rotor blade 221 (or 1003, FIGS. 9a, 9b) to the inlet 321 of the second diffuser 320 and leaves the outlet 322 of the second diffuser 320 having experienced a further reduction in absolute velocity and increase in static pressure. The flow then passes to and from the third rotor blade 231 (or 1003, FIGS. 9a, 9b) to the inlet 331 of the third diffuser 330 and leaves the outlet 332 of the third diffuser 330 having experienced yet another reduction in absolute velocity and increase in static pressure.

The diffusers 300 are arranged at an angle to the axis Z-Z′ of the driveshaft 620 to form a generally conical profile, which reduces the total length of the staged assembly such that it is compact.

Referring to FIG. 8, in another embodiment three similar, generally cylindrical diffuser stages 340, 350, 360 become progressively smaller in the axial direction and are stacked concentrically, thereby reducing the diameter and length of the diffuser assembly. Although three diffuser stages are shown, this principle can be applied to different numbers of stacked stages.

In another embodiment (not shown), the staged diffusers 310, 320, 330, 340, 350, 360 are dissimilar, for example a combination of generally conical and generally cylindrical diffusers.

In embodiments of the invention, the various components discussed above, including the inner tube 400 and the outer casing 500, are made from metals such as aluminium or titanium, or alloys thereof, plastics, or other suitable material which will be apparent to a person skilled in the art. In addition the dimensions or relative dimensions can be varied as appropriate.

In embodiments of the invention, the method of construction of the various components discussed above, including the inner tube 400 and the outer casing 500, includes one or more of machining, casting, rapid-prototyping, injection moulding, forming, welding, adhesive bonding, mechanical fastening, or other suitable means which will be apparent to a person skilled in the art.

Other embodiments of the invention include any desired number of flow guide members 419 and spiral flow passageways 800.

In an embodiment of the invention, at least a portion of the annular flow inlet 804 is of constant cross-section or is convergent in the axial direction.

Embodiments of the invention are suitable for various rotodynamic machines and any appropriate compressor not limited to those having a relatively high tangential velocity component, including, for example, pumps.

The diffuser is suitable for use with a pump with a low specific speed rotor. In general, if the pressure rise is high then the pump may be classed as low specific speed and the claimed diffuser would be useful. One potential application is pumping oil from a well when the diameter of the pump is highly restricted.

Embodiments of the invention are suitable for use with fluids including gases other than air.

In other embodiments of the invention, the electric motor drive is replaced by a turbine to provide power to drive the rotor.

1. A diffuser for a rotodynamic machine, the diffuser comprising:
a flow area having an axially extending and substantially uninterrupted inlet region at an inlet axial end, the inlet region increasing in cross-sectional area in the axial downstream direction; and
a flow guide region including a substantially uninterrupted passageway having tangential and axial directional components and defined by a flow guiding member extending towards an outlet axial end.

2. A diffuser according to claim 1 including inner and outer walls, the outer wall being coaxial with the inner wall to define an annular flow area therebetween, the annulus comprising said flow guide region or flow area.

3. A diffuser according to claim 2 wherein at least one of the inner and outer walls is generally cylindrical or conical.

4. A diffuser according to claim 2 wherein the outer wall contains at least a portion of the inner wall.

5. A diffuser according to claim 1 wherein the inlet axial end includes a radially disposed inlet duct.

6. A diffuser according to claim 1 wherein the passageway is generally spiral or helical.

7. A diffuser according to claim 1 wherein the passageway is of constant cross-sectional area.

8. A diffuser according to claim 1 wherein at least a portion of the passageway is divergent or convergent in the axial direction.

9. A diffuser according to claim 1 wherein the passageway includes an inlet angle of between 70 and 80 degrees with respect to a longitudinal axis of the diffuser.

10. A diffuser according to claim 1 wherein the flow guiding member is continuous over an arc angle of 60 to 90 degrees about a longitudinal axis of the diffuser.

11. A diffuser according to claim 1 including a plurality of substantially uninterrupted passageways each having tangential and axial directional components defined between flow guiding members extending towards the outlet axial end.

12. A diffuser for a rotodynamic machine, the diffuser comprising a flow area having an entry end increasing in cross-sectional area in the axial downstream direction.

13. A diffuser for a rotodynamic machine, the diffuser comprising a flow area including a passageway having tangential and axial directional components and defined by a flow guiding member extending towards the outlet axial end.

14. A diffuser for a rotodynamic machine, the diffuser comprising a flow area having an axially extending and substantially uninterrupted inlet region at an inlet axial end, the inlet region increasing in cross-sectional area in the axial downstream direction.

15. A diffuser for a rotodynamic machine, the diffuser comprising a flow guide region including a substantially uninterrupted passageway having tangential and axial directional components and defined by a flow guiding member extending towards an outlet axial end.

16. A rotodynamic machine, including a rotor and a diffuser comprising:
a flow area having an inlet region at an inlet axial end, the inlet region being provided radially adjacent the rotor periphery and increasing in cross-sectional area in the axial downstream direction;
inner and outer walls, the outer wall being coaxial with the inner wall to define an annular flow area therebetween; and
a flow guide region including a substantially uninterrupted passageway having tangential and axial directional components and defined by a flow guiding member extending towards an outlet axial end.

17. A rotodynamic machine according to claim 16 wherein the rotor is configured to deliver a flow having a ratio of tangential velocity to radial velocity of at least ten.

18. (canceled)

19. A diffuser according to claim 1, wherein the diffuser is part of a compressor.

20. A diffuser according to claim 1, wherein the diffuser is part of a pump.

21. A diffuser according to claim 1, wherein the diffuser is part of the rotodynamic machine.

22. A rotodynamic machine according to claim 16, further comprising a plurality of diffuser stages stacked so as to form a conical profile.
